(19) United States
(12) Patent Application Publication
(10) Pub. No.: US 2003/0077370 A1
(43) Pub. Date: Apr. 24, 2003

(54) Athlete booster snack

(76) Inventors: Gernot Fontaine, Wallerfangen (DE); Heinz Steinhage, Ensdorf (DE)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/132,733

(22) Filed: Apr. 26, 2002

(30) Foreign Application Priority Data
Oct. 19, 2001 (DE) 201 16 998.3

(51) Int. Cl. A21D 10/00

(52) U.S. Cl. 426/549

(57) ABSTRACT

A baked product is used as food for an athlete and provides the energy content in kilocalories. The baked product results from processing a baking mixture comprising a proportion of less than 20% fats, more than 50% carbohydrates, and more than 15% proteins. The processing requires stirring the baking mixture with a liquid, in particular water, and then baking the baking mixture. A further embodiment of the invention includes the baked product in the form of a baked cake wherein the baking mixture is stirred with water in a weight ratio of approximately 150 g water to 140 g baking mixture to form a paste. The resulting paste is placed into a baking mold, and baked at a temperature of at least 150 degrees Celsius. A still further embodiment includes a kit including the baking mixture in a sealable bin, a measuring device, and a baking mold.

The present invention relates to a baking mixture for making athlete snacks and offered in ready-to-bake form and to the athlete snacks so made, in particular in the form of baked oat or barley cakes.

It is known that people such as athletes undergo substantial body exertions but advantageously do recover the lost energy by consuming highly concentrated food. Compared to its fat content, such food contains a high proportion of proteins and carbohydrates. As is well known, such food is marketed in the form of segments (bars) and may be consumed directly. Effective and healthy energy intake is assured by such additions to the daily food intake.

Such known additional food however incurs the drawback that the food bars—which are consumed by the athletes in large numbers to cover their nutritional needs especially where the sports are physically exhausting—are comparatively expensive and thus are likely to be a prohibitive additional expenditure. Moreover the known products taste indifferently and do not therefore whet the appetite. Their consistency often is dense and disagreeable and as a result they may only be consumed by concurrently ingesting a beverage.

The objective of the present invention is to create a food for athletes which is characterized by an attractive and individually selected taste and comprises an appropriate mixture of nutrients while being comparatively economical.

This problem is solved by a baking mixture claimed in claim 1 which allows baking the athlete food claimed in claim 7.

The basic concept of the invention is to offer the athlete stress food not as a finished product, but instead as a prime substance which is a ready-to-bake mixture that allows preparing arbitrary portions into a concentrated and well-tasting booster nutrition. On account of its simple and practical idea of user preparation, the inventive baking mixture is free of complexities and offers any degrees of freedom with respect to athletic training and scheduling. The invention makes possible a health-boosting food at comparatively low costs. Moreover this prime food offers a mixture that is low in fats and high in proteins and carbohydrates and that also may be complemented with vitamins, minerals and enough inert substances. Contrary to the case of the known booster bars, the product of the invention using the said baking mixture will be especially loose and thus shall be very edible. It is especially appetizing on account of its brown, bread-like crust.

The baking mixture of the invention is defined by its energy content (in kcal) of the baked product made by adding liquid. The baked product contains less than 20% fats, more than 50% carbohydrates and more than 15% proteins. These data imply that the energy content per gram of baked product shall be 4.2 kcal proteins, 9.3 kcal fats and 4.2 kcal carbohydrates. The preparation of the invention consists of mere stirring with an appropriate liquid, in particular water, and ensuing baking. For that purpose baking utensils are advantageously joined to the baking mixture. While possible, further ingredients are not mandatory and consequently the invention may be used by anyone without resort to further accessories. Advantageously the required sweetness shall be attained by adding dried bits of fruit, in particular bits of apples, to the said mixture. Further sweetening may be carried out using sweeteners.

The baking mixture of the invention offers clearly lower prices than the manufactured bars. Moreover the taste may be selected from individual to individual and thus will commensurately appeal more to athletes. Be it also noted that the prepared energy boosting food need not be consumed immediately following baking, but instead it may be carried along in parts during the athletics and may be consumed like a bar to meet the needs as they develop. The baking mixture of the invention while entailing preparation does not raise drawbacks when being consumed. The nutrition provided by this baking mixture offers both weight-conscious nutrition and simultaneously will taste good.

Said food also can be used as especially valuable dietetic nutrition in the form of snacks. It may be consumed as concentrated food before, during and/or following athletic activities, without entailing problems of nutrient utilization o affecting well-being. The product of the invention reliably being digestible, the athletes' performance shall be enhanced. Furthermore the invention also is suitable for breakfast and may be used as a meal substitutes in particular diets.

In especially advantageous manner, the baking mixture may be in the form of a complete kit held in containers, making it easy to handle for the consumer. Such a container includes a reclosable bin with a capacity up to about 5 liters in particular. Said a bin is filled with baking mixtures and also contains a measuring device, in particular a measuring cup and a baking mold. The consumer may select the amount of baking mixture and water using said measuring device and place them in a bowl and stir them. The stirred paste may be filled into said baking mold which in an especially simple and therefore advantageous form shall merely be a flat cardboard food plate and then said paste shall be flattened before being put into an oven. In this manner a brown, crusty bar of the booster food can be made and optionally be cut into appropriate portions.

A particular embodiment of the invention is elucidated below.

One embodiment within the above cited scope of the present invention of the baked product made from the inventive baking mixture contains between 8 and 12% fats, in particular 10%, between 60 and 70% carbohydrates, in particular 65%, and between 20 and 30% proteins, in particular 25%. These final product proportions can be attained from a baking mixture to which a liquid (water) was added and which is composed of up to 50 parts flour, of up to 10 parts bran, in particular wheat food bran, up to 8 parts oil seeds, in particular flax seeds, up to 15 parts protein powder, up to 15 parts flakes, in particular oat flakes, up to 10 parts butter milk powder, up to 10 parts wheat gluten, up to 10 parts curd cheese powder and up to 10 parts milk ingredients such as powdered milk, lactose or lactoprotein. Spices and/or flavors as well as dried bits of fruits are added to the above ingredients. The mixture also contains sweeteners or sugar, baking powder, yeast, vitamins and minerals. A booster snack made from such a baking mixture will contain, per 100 g, as follows: about 0.1 to 0.3 g, in particular 0.2 g of sodium; 0.1 g to 0.3 g, in particular 0.2 g calcium; and 0.1 to 0.3 g, in particular 0.12 g of magnesium; further about 0.5 mg vitamin B1, 0.4 mg vitamin B2 and 0.4 mg vitamin B1 as well as 0.2 mg folic acid, This composition covers up to 40% of the daily requirement. In this composition, the inert ingredients amount to 4.5 g.

The baking mixture is processed in such a way that it shall be stirred with water in a weight ratio of water to baking mixture of 150 g/140 g, the paste then being fed into a baking mold and being baked thereupon in ambient air at a temperature of at least 150° C., especially at 190° C. for almost 20 minutes.

1. A baking mixture from which to process a baked product to serve as athlete food and providing an energy content in kcal. resulting from a proportion of less than 20% fats, more than 50% carbohydrates and more than 15% proteins, said processing merely requiring stirring with a liquid, in particular water, and then baking.

2. Baking mixture as claimed in claim 1, characterized in that the baked product's energy content is provided by a proportion of 8 to 12, in particular 10% fats, a proportion between 60 and 70, in particular 65% carbohydrates and a proportion between 20 and 30, in particular 25% proteins.

3. Baking mixture as claimed in either of claims 1 and 2, characterized by:
up to 50% flour,
up to 10% bran,
up to 8 parts oil seeds, in particular flax seeds,
up to 15 parts protein powder,
up to 15 parts cereal flakes, in particular oat flakes,
up to 10 parts buttermilk powder,
up to 10 parts gluten, in particular wheat gluten,
up to 15 parts curd cheese powder,
up to 10 parts milk ingredients such as milk powder, lactose or lactoprotein.

4. Baking mixture as claimed in claim 3, characterized by also containing bits of fruit, in particular bits of apples.

5. Baking mixture as defined in one of the above claims, characterized by adding spices and/or flavors, sweeteners and/or sugar and/or baking powders and/or yeasts and/or vitamins and/or minerals.

6. Baking mixtures as claimed in one of the above claims, characterized by:
containing 0.1 to 0.3, in particular 0.2 g sodium,
containing 0.1 to 0.3, in particular 0.2 g magnesium,
containing 0.1 to 0.3, in particular 0.12 g magnesium.

7. Athlete food, in particular in the form of a baked cake, processed from the baking mixture as claimed in one of the above claims, characterized in that the baking mixture is stirred with water in a weight ratio approximately of 150 g water to 140 g making mixture, in that then the paste is placed into a baking mold and in that then the paste is baked at a temperature at least of 150° C.

8. A kit containing a baking mixture filled into a sealable bin as claimed in one of the above claims and including a measuring device, in particular a measuring cup and a baking mold.

9. A kit as claimed in claim 8, characterized in that the baking mold is a flat cardboard food plate.
